(19) United States
(12) Patent Application Publication
(10) Pub. No.: US 2006/0164861 A1
(43) Pub. Date: Jul. 27, 2006

(54) Lighting apparatus and liquid crystal display

(75) Inventors: Satoshi Maeda, Kawasaki (JP); Hirokazu Aritake, Kawasaki (JP)

Correspondence Address: GREER, BURNS & CRAIN, 300 S WACKER DR, 25TH FLOOR, CHICAGO, IL, 60606, US

(73) Assignees: FUJITSU LIMITED; SHARP KABUSHIKI KAISHA

(21) Appl. No.: 11/352,415

(22) Filed: Feb. 10, 2006

Related U.S. Application Data
(63) Continuation of application No. PCT/JP03/10315, filed on Aug. 13, 2003.

(51) Int. Cl. F21V 7/04

(52) U.S. Cl. 362/615

(57) ABSTRACT

The lighting apparatus comprises light sources (16) and a planar light conductor (18). The planar light conductor (18) includes opposed surfaces, side surfaces and end surfaces, and a plurality of prisms (28) are provided on one of the end surfaces (23). Said a plurality of prisms (28) have the function of the linear light conductor and provides a solid planar light conductor. The configuration of said plurality of prisms (28) is varied in accordance with positions thereof. The light source (16) is arranged so that the light is incident from position near the end surface. One of the opposed surfaces has means (26) for causing the light propagating inside the planar light conductor to exit from said one of the surfaces. The side surfaces or the bottom surface of the planar light conductor has slit (30, 32) or a groove (34). The liquid crystal display includes the lighting apparatus.

### CROSS REFERENCE TO RELATED APPLICATION

This application is a Continuation of International Application No. PCT/JP03/10315, with an international filing date of Aug. 13, 2003, which designated the United States of America.

### TECHNICAL FIELD

The present invention relates to a lighting apparatus and a liquid crystal display.

### BACKGORUND ART

Liquid crystal displays, which are thin and light, are widely used as displays of portable information terminals. Liquid crystal itself is a light-receiving device which does not radiate by itself and includes a lighting apparatus for lighting the liquid crystal panel. The liquid crystal display is classified in transmitting liquid crystal display and the reflective liquid crystal display. The transmitting liquid crystal display has a lighting apparatus (back light) arranged on the side of the back, and the reflective liquid crystal display has a lighting apparatus (front light) arranged on the front side. The sunlight or light of room lights is applied to the reflective liquid crystal display, and, in such lighting circumstances, the reflective liquid crystal display does not require the lighting apparatus. In circumstances without such light, however, the reflective liquid crystal display requires the lighting apparatus. In either liquid crystal display, linearly polarized light has the phase modified by the property of the liquid crystal when passes through the liquid crystal, passes the color filter and is transmitted or blocked by the polarizer, whereby the white or black indication of one dot is made. A plurality of the dots are arranged to form letter information and image information.

The conventional lighting apparatus includes a light source, a linear light conductor and a planar light conductor (refer to, e.g., the specification of Japanese Patent Application Unexamined Publication No. Hei 10-260405 and the specification of Japanese Patent Application Unexamined Publication No. 2003-77326). The light source, as of LEDs, is arranged on a side of the linear light conductor, and the linear light conductor is arranged adjacent to the planar light conductor. The light of the light source is incident on the side of the linear light conductor, is reflected on a plurality of prisms provided on a side of the linear light conductor to be incident on the planar light conductor. The planar light conductor includes a light emitting means, as of prisms, etc. and emits the light propagating in the planar light conductor toward the liquid crystal panel.

Furthermore, the lighting apparatus preferably has a uniform intra-plane distribution of luminance. Recently, the liquid crystal panels and liquid crystal displays used in information terminals require lighting apparatus having improved display qualities, such as coloring, higher luminance and higher resolution, and having simple structures which can decrease the cost.

However, in the above-described lighting apparatus, the light source, the linear light conductor and the planar light conductor are separately made and are fabricated into one assembly. Accordingly, the constituent parts are many, and the steps of the fabrication are many, which disadvantageously increases the cost

### DISCLOSURE OF THE INVENTION

An object of the present invention is to provide a lighting apparatus which has a uniform luminance distribution and is inexpensive, and a liquid crystal display including the lighting apparatus.

The lighting apparatus according to the present invention comprises a light sources; and a planar light conductor, the planar light conductor including opposed surfaces, side surfaces and end surfaces, a plurality of prisms being provided on one end surface, said plurality of prisms having configurations varied in accordance with positions thereof, the light sources being arranged so that light can be incident on the side surfaces from positions near said one end surface, and one of the opposed surfaces having means for causing the light propagating inside the planar light conductor to exit.

The lighting apparatus according to the present invention comprises light sources; and a planar light conductor, the planar light conductor including opposed surfaces, side surfaces and end surfaces, a plurality of prisms being provided on one end surface, the light source being arranged so that light can be incident on the side surfaces from positions near said one end surface, the planar light conductor includes a groove or a slit near said a plurality of prisms, and one of the opposed surfaces having means for causing the light propagating inside the planar light conductor to exit.

Furthermore, the liquid crystal display according to the present invention comprises a liquid crystal panel and a lighting apparatus for lighting the liquid crystal panel. The lighting apparatus can have either of the above-described structures.

In the above-described structures, a plurality of prisms having the function of the linear light conductor are provided on one end surface of the planar light conductor, and the planar light conductor is integrated with the conventional linear light conductor, whereby the display quality, such as the luminance distribution, etc., is retained while the linear light conductor, which has been conventionally formed as a separate constituent part, is omitted to thereby decrease the number of the constituent parts to decrease the cost.

Especially, the angle of the plural prisms provided on one end surface of the planar light conductor is varied in accordance with positions thereof, whereby the luminance distribution of the light exiting from the planar light conductor can be made uniform.

Furthermore, the planar light conductor has a groove or splits near the plural prisms, whereby the light totally reflected on the surface of the groove or the surfaces of the slits is deflected by the plural prisms, whereby the light incident on the planar light conductor can be effectively utilized, and the luminance can be improved.

### BRIEF DESCRIPTION OF THE DRAWINGS

FIG. 1 is a perspective view of the liquid crystal display including the back light according to an embodiment of the present invention.

FIG. 2 is a perspective view of the liquid crystal display including the front light according to the embodiment of the present invention.

FIG. 3 is a perspective view of the lighting apparatus according to an embodiment of the present invention.

FIG. 4 is a perspective view of the lighting apparatus according to a control.

FIG. 5 is a view of the luminance of the light exiting from the planar light conductor.

FIG. 6 is a view illustrating the configurations of the prisms provided on the end surface of the planar light conductor.

FIG. 7 is a view illustrating the configuration of the prisms positioned in the middle of the end surface of the planar light conductor of FIG. 3.

FIG. 8 is a view illustrating the configuration of the prisms positioned at the ends of the end surface of the planar light conductor of FIG. 3.

FIG. 9 is a perspective view of an embodiment of the liquid crystal display illustrated together with the convergerd light.

FIG. 10 is a view illustrating the configuration of the prisms positioned in the middle of the end surface of the planar light conductor of another embodiment.

FIG. 11 is a view illustrating the configuration of the prisms positioned at the end of the end surface of the planar light conductor of another embodiment.

FIG. 12 is a perspective view of the liquid crystal display illustrated together with the parallel light.

FIG. 13 is a perspective view of the planar light conductor of another embodiment.

FIG. 14 is a view illustrating the configuration of the prisms of the planar light conductor of FIG. 13.

FIG. 15 is a perspective view of the planar light conductor of another embodiment.

FIG. 16 is a view illustrating the configuration of the prisms of the planar light conductor of FIG. 15.

FIG. 17 is a perspective view of the planar light conductor of another embodiment.

FIG. 18 is a perspective view of the planar light conductor of another embodiment.

FIG. 19 is a diagrammatic plan view of the planar light conductor of FIG. 18.

FIG. 20 is a perspective view of the planar light conductor of another embodiment.

FIG. 21 is a diagrammatic plan view of the planar light conductor of FIG. 20.

FIG. 22 is a perspective view of the planar light conductor of another embodiment.

FIG. 23 is a diagrammatic side view of the planar light conductor of FIG. 22.

FIG. 24 is a diagrammatic back side view of the planar light conductor of FIG. 22.

FIG. 25 is a perspective view of the planar light conductor of another embodiment.

FIG. 26 is a perspective view of the planar light conductor of another embodiment.

FIG. 27 is a perspective view of the planar light conductor of another embodiment.

### BEST MODES FOR THE CARRYING OUT THE INVENTION

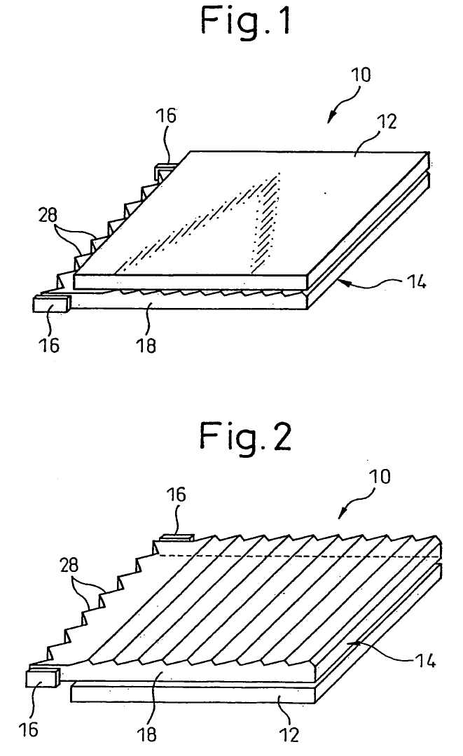

FIG. 1 is a perspective view of a liquid crystal display including the back light according to an embodiment of the present invention. The liquid crystal display 10 includes a liquid crystal panel 12, and a lighting apparatus 14 arranged on the side of the back of the liquid crystal panel 12. The liquid crystal panel 12 includes a liquid crystal sealed in a pair of glass substrates, and polarizers arranged on both sides of the liquid crystal panel 12. In this case, light of the lighting apparatus 14 passes through the liquid crystal panel 12 and arrives at a viewer.

FIG. 2 is a perspective view of a liquid crystal display including a front light according to an embodiment of the present invention. The liquid crystal display 10 includes a liquid crystal panel 12, and a lighting apparatus 14 arranged on the side of the front side of the liquid crystal panel 12. The liquid crystal panel 12 is a reflective liquid crystal panel having a reflection film, and the light of the lighting apparatus 14 passes through a liquid crystal in the liquid crystal panel 12, then reflected on the reflection film, passes through again the liquid crystal to be emitted from the liquid crystal panel 12. In FIGS. 1 and 2, in order to make the luminance distribution uniform, various optical parts and optical films, such as a scattering plate, a BEF sheet, etc., may be used together with the lighting apparatus 14.

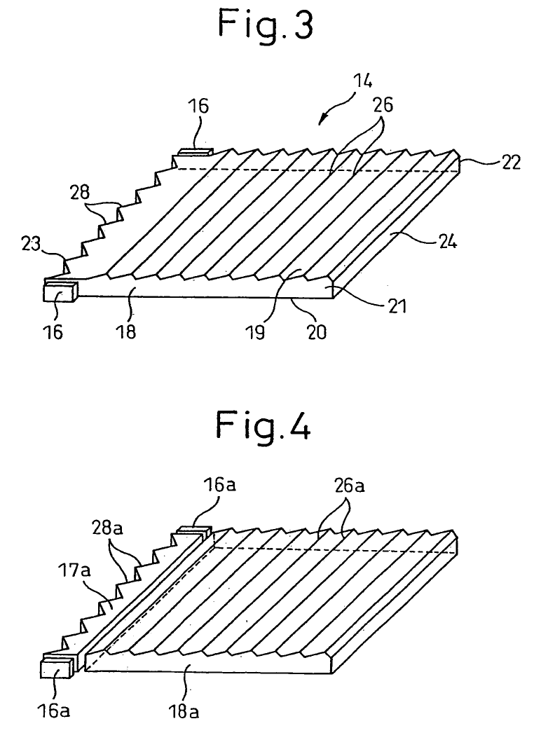

FIG. 3 is a perspective view of the lighting apparatus according to en embodiment of the present invention. This lighting apparatus 14 (and a lighting apparatus 14 which will be explained later) are usable as the lighting apparatus 14 of FIGS. 1 and 2. The lighting apparatuss 14 in FIGS. 1 to 3 each include light sources 16 and a planar light conductor 18. The light sources 16 are spot light sources each include white LEDs. The planar light conductor 18 is made of transparent resin or glass and is a substantially rectangular plate having surfaces 19, 20 opposed to each other, side surfaces 21, 22 and end surfaces 23, 24. The surface 19 is a surface from which light exits and has a plurality of prisms 26 as means for causing the light propagating in the planar light conductor 18. The prisms 26 are extended from the side surface 21 to the side surface 22 perpendicularly to the axial line of the planar light conductor 18. The means for causing the light to exit is not limited to the prisms 26 and may be a scattering layer or a reflection layer.

A plurality of prisms 28 are provided on the end surface 23 of the planar light conductor 18. The prisms 28 are extended from the surface 19 to the surface 20 vertically to the surface 19 and are coated with a reflection film. The light sources 16 are disposed on the respective side surfaces 21, 22 at positions near the end surface 23. That is, the light sources 16 are so arranged that the light is incident on the side surfaces 21, 22 from the positions near the end surface 23. The light incident on the planar light conductor 18 is reflected on the plural prisms 28 and deflected to propagate inside the planar light conductor 18 in the direction substantially parallel with the axial line of the planar light conductor 18 (the direction parallel with the side surfaces 21, 22) and finally exits from the surface 19.

FIG. 4 is a perspective view of the lighting apparatus according to a Control. The conventional lighting apparatus includes light sources 16a, a linear light conductor 17a and a planar light conductor 18a. The linear light conductor 17a includes a plurality of prisms 28a. The light sources 16a are disposed on the sides of the linear light conductor 17a, and the linear light conductor 17a is disposed adjacent to the planar light conductor 18a. The light of the light sources 16a is incident on the side surfaces of the linear light conductor 17a and is reflected on a plurality of prisms 28 disposed on an end surface of the linear light conductor 17a to enter the planar light conductor 18a. The light propagating inside the planar light conductor 18a exits toward the liquid crystal panel.

The action of the lighting apparatus 14 illustrated in FIG. 3 is basically the same as the action of the lighting apparatus illustrated in FIG. 4. However, the lighting apparatus illustrated in FIG. 4 is fabricated by assembling into one from the light sources 16a, the linear light conductor 17a and the planar light conductor 18a, which are separately made. Accordingly, the parts are many, and the fabrication steps are many, which increases the cost. In contrast to this, in the present invention, a plurality of prisms 28 having the action of the linear light conductor 18a are disposed on the end surface 23 of the planar light conductor 18, whereby the optical characteristics can be sustained, the number of the constituent parts can be small, and cost reduction can be realized.

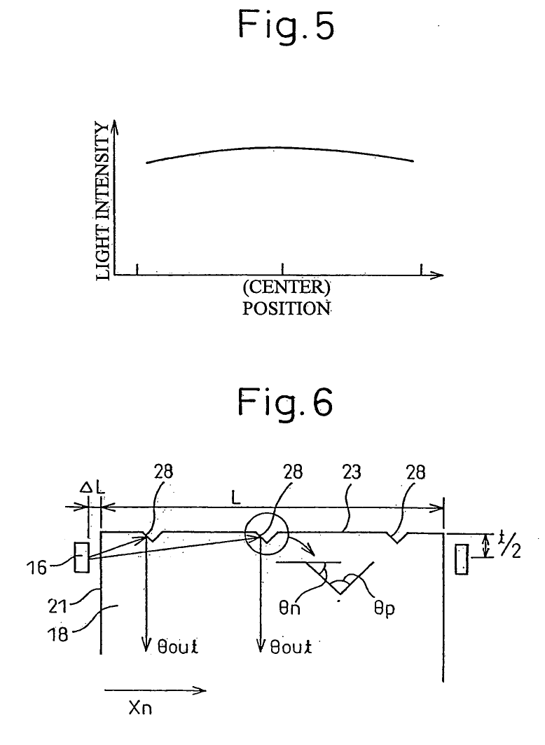

In the present embodiment, the configuration of the plural prisms 28 disposed on the end surface 23 of the planar light conductor 18 varies in accordance with the positions along the end surface 23. That is, the configuration of the prisms 28 is varied so that the light emitted by the light sources 16 is reflected on the slant surfaces of the prisms 28 to propagate substantially parallel with the axial line of the planar light conductor 18. The configuration of the prisms 28 are varied so that substantially parallel light can be obtained, whereby the lighting apparatus can have the uniform luminance as shown in FIG. 5.

FIG. 6 is a view illustrating the configuration of the prisms 28 disposed on the end surface 23 of the planar light conductor 18. n is a number of the prisms 28 disposed on the end surface 23 of the planar light conductor 18. Only parts of the prisms 28 are illustrated, but a number of the prisms 28 are disposed at a certain pitch. Also in the other drawings, parts of the prisms 28 are illustrated, but in these cases as well, a number of prisms 28 are disposed at a certain pitch. In a 2-inch liquid crystal panel, 150 prisms 28 are disposed at a 0.23 mm-pitch.

Each prism 28 has two tilt faces. A tilt angle of the tilt face of the prisms 28 opposed to one of the light sources 16 is θn. In this case, the tilt angle θn is an angle to the line perpendicular to the axial line of the planar light conductor (the line parallel to the end surface 23). θout is an angle of the light emitted by the light source 16 and reflected on the tilt surface of the prism 28 to the straight line parallel to the axial line of the planar light conductor 18. A width of the planar light conductor 18 is L, a distance between the light source 16 and the planar light conductor 18 is ΔL. The ΔL is approximated to 0 as much as possible. A distance between the center of the light source 16 and the end surface 23 of the planar light conductor 18 (the outer edge of the tilt face of the prism 28) is t/2. Xn is a distance between the side surface 21 of the planar light conductor 18 and n-th prism 28 in the X direction.

The tilt angle θn of the tilt face of the prism 28 opposed to one light source 16 is given by the following formula 1.

$$θ ( n ) = \frac{{tan}^{- 1} ( \frac{Δ L + X ( n )}{\frac{1}{2} t} ) + {θ}_{out} ( n )}{2 } \qquad ( 1 )$$

The tilt angle of one tilt face of the prism 28 opposed to one light source 16 can be thus given. Furthermore, the tilt angle of the other tilt face of the prism 28 opposed to the other light source 16 can be given in the same way. It is possible to given the title angle of one tilt face of the prism 28 opposed to one light source 16, and the title angle of the other face of the prism 28 opposed to the other light source 16 can be given with a central angle θ of the groove of the prism 28 being constant. This allows the cutting of the prisms 28 to be made at lower costs. The prisms 28 may not have respectively different configurations, and groups of the prisms 28 may have respectively different configurations.

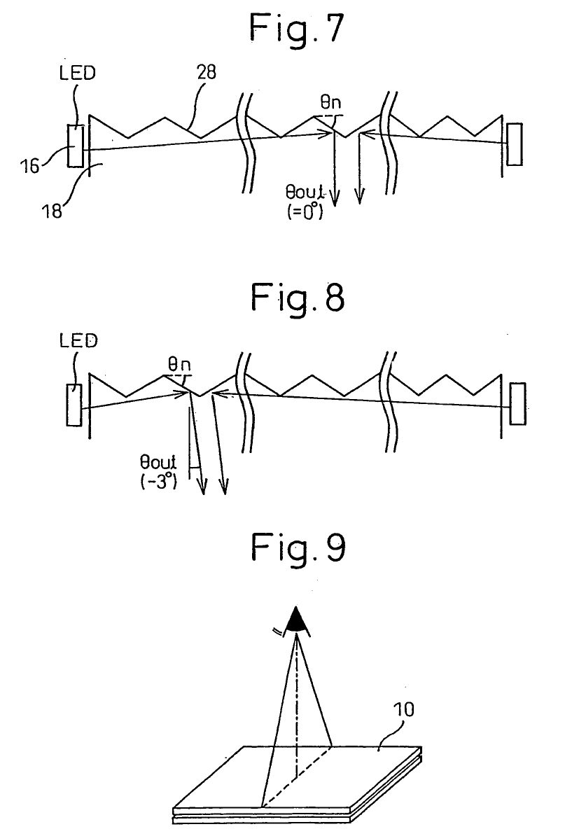

FIGS. 7 to 9 illustrate an embodiment of the configuration of the prisms 28. FIG. 7 illustrates the configuration of the prism 28 position in the middle of the end surface 23. For the configuration of the prism 28 positioned in the middle, θn is given with θout being 0 degree. FIG. 8 illustrates the configuration of the prism 28 positioned at the ends of the end surface 23. For the configuration of prism 28 positioned at the end, θn is given with θout being −3 degrees. When a viewer looks at the liquid crystal panel 12 as illustrated in FIG. 9, the light converged in the range of ±3 enter the viewer's eyes. In the portable telephone, for embodiment, it is preferable in terms of the relationship between the length of the arm and the position of the eyes that the light of ±3 degree, +3 degrees at one end of the panel, −3 degrees at the other end and 0 degree in the middle is incident on the eyes. The configurations (angles) of a plurality of the prisms 28 are thus varied so as to have required angles (e.g., from +3 degrees to −3 degrees) in accordance with the positions of the prisms 28, whereby the lighting optical system can have a uniform distribution. The prisms 26 of the planar light conductor 18 are arranged at angles which converge light to the eyes of a viewer, whereby the luminance can be increased.

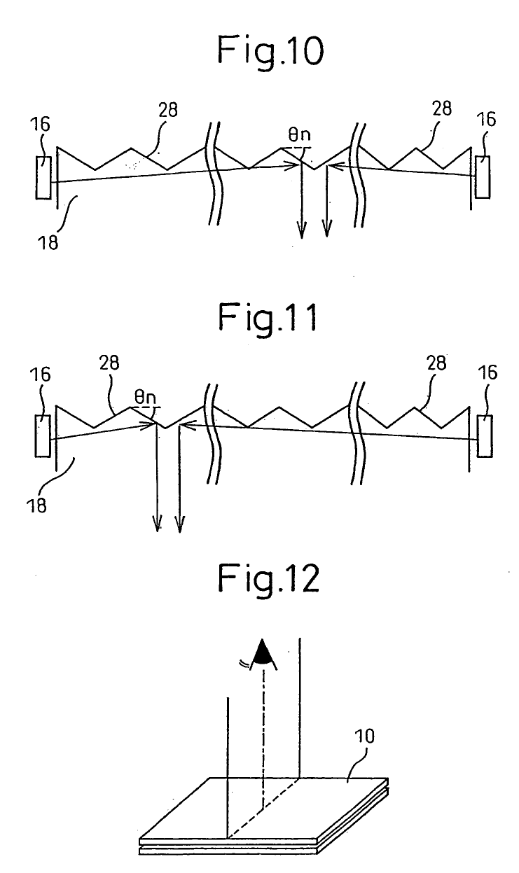

FIGS. 10 to 12 illustrate an embodiment of the configuration of the prisms 28. FIG. 10 is a view illustrating the configuration of the prism 28 positioned in the middle of the end surface 23. For the configuration of the prism 28 positioned in the middle, θn is given with θout being 0 degree. FIG. 11 illustrates the configuration of the prisms 28 positioned at the ends of the end surface 23. For the configuration of the prisms 28 positioned at the ends, θn is given with θout being 0 degree. In this case, as illustrated in FIG. 12, when a viewer looks at the liquid crystal panel 12, parallel light enters the eyes of the viewer. The structure illustrated in FIG. 9 can converge all the light at one point, and the display can be made very bright. However, when the eyes are off the converging point, the display is dark. Then, as illustrated in FIG. 12, parallel light is emitted from the lighting apparatus 14 to arrives uniformly at all the positions, whereby the display can be made generally bright.

In the embodiments described above, the end surface 23 of the planar light conductor 18 is formed substantially straight. That is, the outer ends of the tilt faces of the plural prisms 28 are positioned on one straight line. However, the end surface 23 of the planar light conductor 18 may be formed, curved outward with the middle thereof positioned outer than the ends thereof. That is, the tops of the plural prisms 28 are positioned on a curve. Thus, the end surface 23 of the planar light conductor 18 is bulged outward in a polygon or a curve, whereby the luminance can be improved. Thus, one sheet of the planar light conductor 18 can provide good optical characteristics and can realize the cost reduction. The planar light conductor 18 having such characteristics will be explained below.

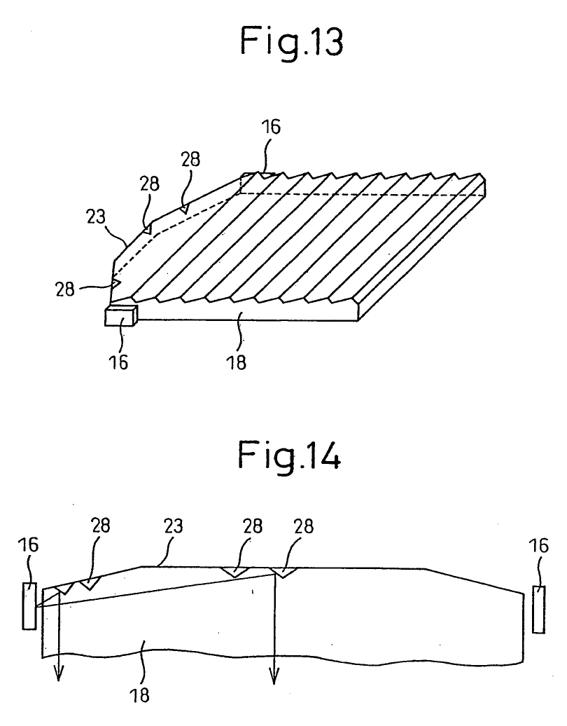

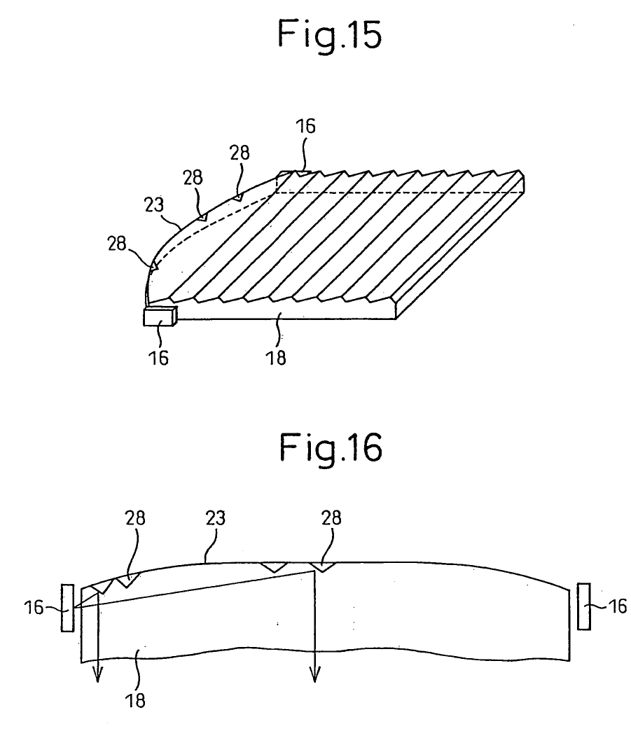

FIG. 13 is a perspective view of the planar light conductor of another embodiment. The end surface 23 of the planar light conductor 18 with a plurality of the prisms 28 is formed in a polygon. FIG. 14 is a view of the configurations of the prisms 28 of the planar light conductor 18 of FIG. 13. The configurations of the prisms 28 can be determined by using Formula 1 described above. In this case, the shape of the end surface 23 is varied, which changes the value of t in FIG. 1. At the ends of the end surface 23, the light incident from the light sources 16 at large angels can be utilized. In the middle of the end surface 23, the light incident from the light sources 16 at a relatively small angle can be utilized without being influenced by the other nearby prisms 28. Thus, the ends and the middle can be made brighter, and the center as a whole can be brighter.

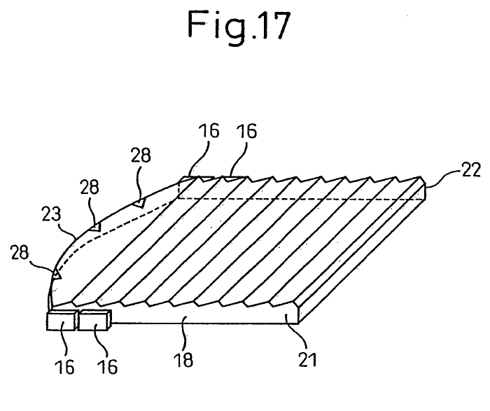

FIG. 15 is a perspective view of the planar light conductor of another embodiment. The end surface of the planar light conductor 18 with a plurality of the prisms 28 is formed in a curve. FIG. 16 is a view of the configurations of the prisms 28 of the planar light conductor in FIG. 15. In this embodiment as well as the embodiment of FIGS. 13 and 14, in which the end surface 23 is polygonal, the center can be made brighter, and without the bends of the polygon, the display quality can be higher. The angles of the plural prisms 28 can be set so that the light substantially from the centers of the light sources 16 can be made parallel. Otherwise, the angles of the plural prisms 28 can be set so that the light is converged to the eyes of a viewer.

FIG. 17 is a perspective view of the planar light conductor of another embodiment. In this embodiment, two light sources 16 are provided on each of the side surfaces 21, 22 of the planar light conductor 18. A plurality of the light sources 16 are provided on each side, whereby higher luminance can be provided.

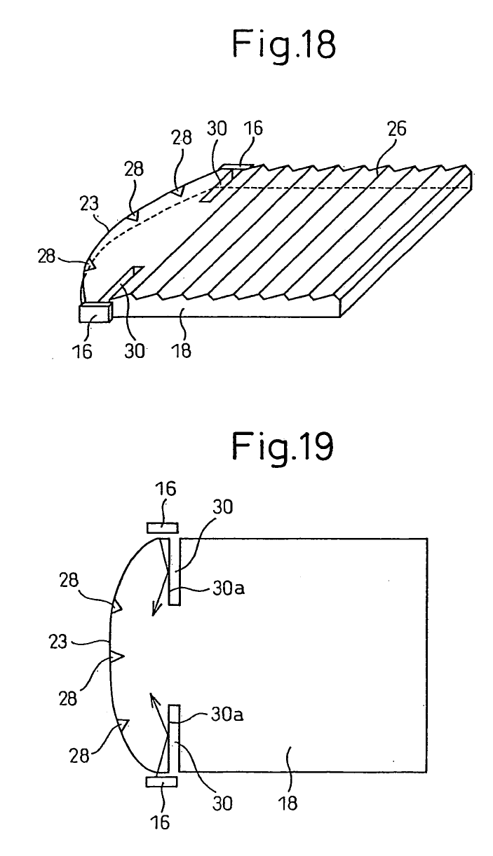

FIGS. 18 to 24 are perspective views of the planar light conductor of other embodiments. In these embodiments, a plurality of prisms 28 are provided on the end surface 23 of the planar light conductor 18. Accordingly, these embodiments act basically in the same way as the embodiments described above. Furthermore, in these embodiments, the planar light conductor 18 has a groove or slits near a plurality of the prisms 28. The groove or the slits are extended perpendicularly to the axial line of the planar light conductor 18. In these embodiments, the end surface 23 is curved but may not be essentially curved.

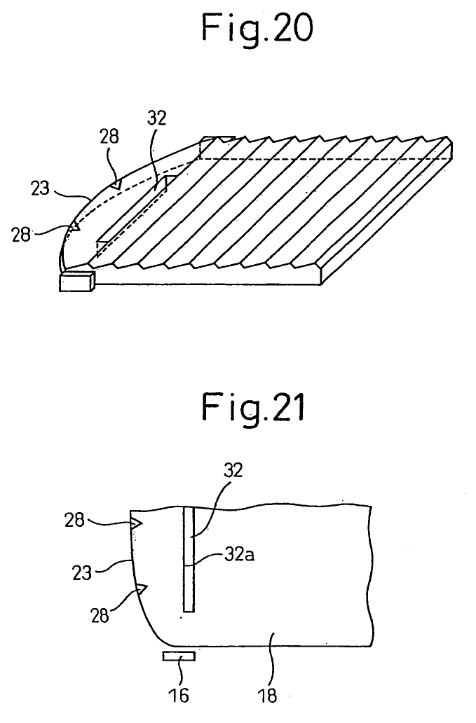

FIG. 18 is a perspective view of the planar light conductor of another embodiment. FIG. 19 is a diagrammatic plan view of the planar light conductor of FIG. 18. In FIGS. 18 and 19, the planar light conductor 18 has slits 30 near a plurality of prisms 28. The slits 30 are provided on the side opposite to the end surface across the extension of the light sources 16. The slits 30 are extended vertically to the axial line of the planar light conductor 18. The slits 30 are cut throughout both surfaces 19, 20 of the planar light conductor 18 and are extended over a certain distance inward from the side surfaces 21, 22 of the planar light conductor 18. The planar light conductor 18 is uninterrupted between both the slits 30.

The light emitted by the light sources 16 and propagating in the planar light conductor 18 is totally reflected on the surfaces 30a of the slits 30 on the side of the end surface 23. The light emitted by the light sources 16 and entering the planar light conductor 18 propagate inside the planar light conductor 18 at various angles. In the embodiments described above, the light propagating toward the end surface 23 of the planar light conductor 18 is reflected on the prisms 28 on the end surface 23 and deflected to propagate substantially parallel with the axial line of the planar light conductor 18. The light propagating oppositely to the end surface 23 of the planar light conductor 18 propagates at the same angle inside the planar light conductor 18 to exit from the surface 19 of the planar light conductor 18 at large angles. The light exiting the surface 19 of the planar light conductor at large angles does not substantially contribute to the display. Because of the slits 30, the light propagating oppositely to the end surface 23 as shown in FIG. 19 is totally reflected on the surfaces 30a and deflected to propagate to the end surface 23. The light thus caused to propagate to the end surface 23 is reflected on the prisms 28 on the end surface 23 and deflected to propagate inside the planar light conductor 18 at angles at which the light is substantially parallel with the axial line of the planar light conductor 18. Thus, the light incident on the planar light conductor 18 can be effectively utilized, and the luminance can be improved.

FIG. 20 is a perspective view of the planar light conductor of another embodiment. FIG. 21 is a diagrammatic plan view of the planar light conductor. FIGS. 20 and 21, the planar light conductor 18 has a slit 32 near the plural prisms 28. The slit 32 is formed through both the surfaces 19, 20 of the planar light conductor 18 and is formed in the middle of the planar light conductor 18, extended perpendicularly to the axial line of the planar light conductor 18. The planar light conductor 18 is not uninterrupted on both sides of the slit 32.

In this case as well, the slit 30 is provided on the side opposite to the end surface 23 across the extension of the light sources 16. The surface 32a of the slit 32 on the side of the end surface 23 totally reflect the light propagating in the planar light conductor 18. Accordingly, the action of this embodiment is the same as that of the previous embodiment.

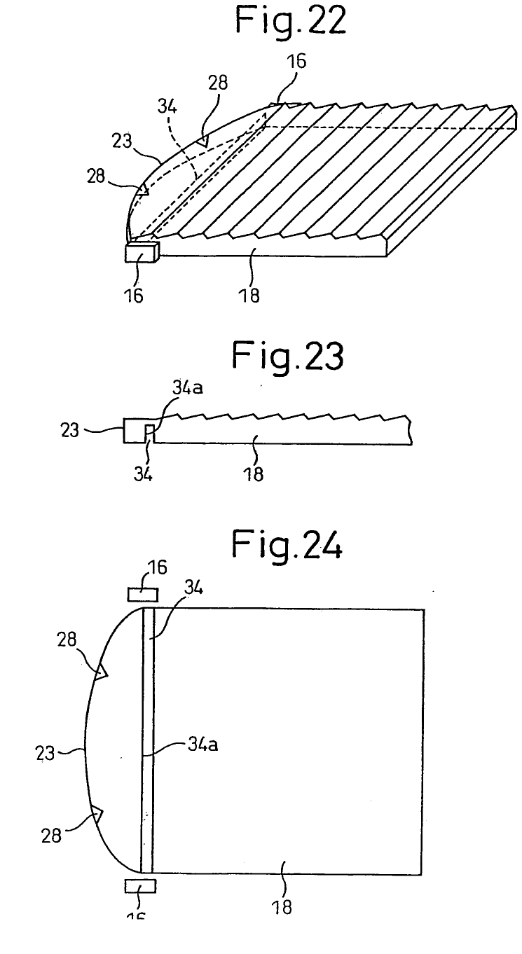

FIG. 22 is a perspective view of the planar light conductor of another embodiment. FIG. 23 is a diagrammatic side view of the planar light conductor of FIG. 22. FIG. 24 is a diagrammatic bottom view of the planar light conductor 22. In FIGS. 22 to 24, the planar light conductor 18 has a groove 34 near the plural prisms 28. The groove 34 is opened in the surface 20 of the planar light conductor 18 and is extended perpendicularly to the axis line of the planar light conductor 18 between both the side surfaces 21, 22 of the planar light conductor 18. The planar light conductor 18 is uninterrupted upper of the groove 34.

In this case as well, the groove 34 is disposed on the side opposite to the end surface 23 across the extension of the light sources 16, and the surface 34a of the end surface 23 of the slit 32 totally reflects the light propagating in the planar light conductor 18. Accordingly, the action of this embodiment is the same as that of the embodiments described above.

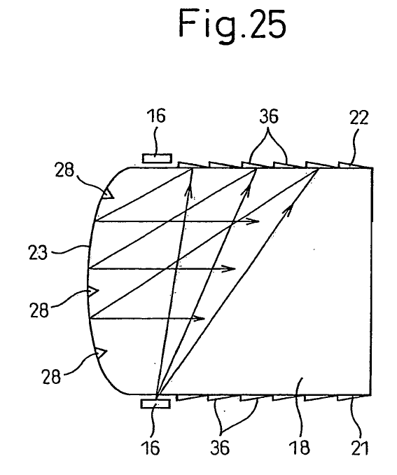

FIGS. 25 to 27 are perspective views of the planar light conductor of other embodiments. In these embodiments, a plurality of prisms 28 are disposed on the end surface 23 of the planar light conductor 18. Accordingly, these embodiments have the same action as the embodiments described above. In these embodiments, the planar light conductor 18 further includes a plurality of prisms on the side surfaces 21, 22 or on the surface 20. In these embodiments, the end surface 23 is curved but is not essentially curved.

In FIG. 25, a plurality of prisms 36 are further provided on the side surfaces 21, 22 of the planar light conductor 18. The light emitted by the light sources 16 and propagating oppositely to the end surface 23 of the planar light conductor 18 is reflected on the prisms 36 to propagate to the end surface 23. The light thus propagating to the end surface is reflected on the prisms 28 on the end surface 23 and deflected to propagate in the planar light conductor 18 at angles at which the light propagates substantially parallel with the axial line of the surface light plate 18. Thus, the light incident on the planar light conductor 18 can be effectively utilized, and the luminance can be improved.

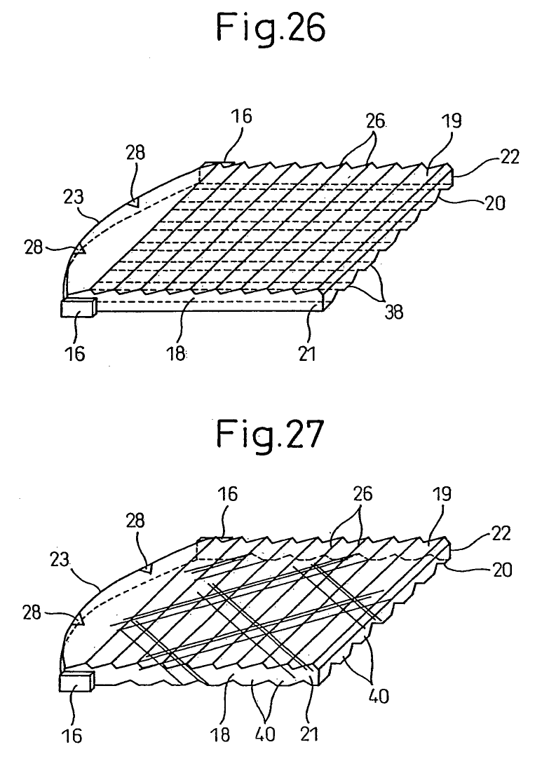

In FIG. 26, a plurality of prisms 38 are further provided under the bottom surface 20 of the planar light conductor 18. The prisms 26 on the surface 19 of the planar light conductor 18 are extended perpendicularly to the axial line of the planar light conductor 18, but the prisms 38 on the surface 20 of the planar light conductor 18 are extended parallel with the axial line of the planar light conductor 18. Accordingly, the light emitted by the light sources 16 and propagating oppositely to the end surface 23 of the planar light conductor 18 is reflected and deflected upward on the tilt surfaces of the prisms 38 faced to the associated light sources 16 and deflected upward to exit from the surface 19. Thus, the light incident on the planar light conductor 18 can be effectively utilized, and the luminance can be improved.

In FIG. 27, a plurality of prisms 40 are further provided on the surface 20 of the planar light conductor 18. The prisms 40 are extended obliquely to the axial line of the planar light conductor 18 and intersect each other. Accordingly, the light emitted by the light sources 16 and propagating oppositely to the end surface 23 of the planar light conductor 18 is deflected to propagate upward, as is deflected by the prisms 38 in FIG. 26, and to approach substantially parallel with the axial line of the planar light conductor 18. Thus, the light incident on the planar light conductor 18 can be effectively utilized, and the luminance can be improved.

As described above, according to the present invention, a plurality of prisms having the function of the linear light conductor is provided on the end surface of the planar light conductor, whereby a lighting apparatus which has the optical characteristics improved by the simple structure and can realize the cost reduction, and a liquid crystal display including the lighting apparatus can be provided.

1. A lighting apparatus comprising:
light sources; and
a planar light conductor,
the planar light conductor including opposed surfaces, side surfaces and end surfaces,
a plurality of prisms being provided on one end surface,
said plurality of prisms having configurations varied in accordance with positions thereof,
the light sources being arranged so that light can be incident on the side surfaces from positions near said one end surface, and
one of the opposed surfaces having means for causing the light propagating inside the planar light conductor to exit.

2. A lighting apparatus according to claim 1, wherein
the means provided on said one of the opposed surfaces comprises a plurality of prisms.

3. A lighting apparatus according to claim 1, wherein
said one end surface is formed substantially straight.

4. A lighting apparatus according to claim 1, wherein
said one end surface is curved with the middle thereof bulged outer than the ends thereof.

5. A lighting apparatus according to claim 1, wherein
said a plurality of prisms on said one end surface transforms light from point-like light sources to parallel light.

6. A lighting apparatus according to claim 1, wherein
said a plurality of prisms transform light from point-like light sources to light converged to the eyes of a viewer.

7. A lighting apparatus according to claim 1, wherein
the planar light conductor includes a groove or a slit near said plurality of prisms.

8. A lighting apparatus according to claim 1, wherein
the planar light conductor includes a plurality of prisms on said side surfaces or the other surface.

9. A lighting apparatus comprising:
light sources; and
a planar light conductor,
the planar light conductor including opposed surfaces, side surfaces and end surfaces,
a plurality of prisms being provided on one end surface,
the light source being arranged so that light can be incident on the side surfaces from positions near said one end surface,
the planar light conductor includes a groove or a slit near said a plurality of prisms, and
one of the opposed surfaces having means for causing the light propagating inside the planar light conductor to exit.

10. A liquid crystal display comprising:
a liquid crystal panel; and
a lighting apparatus for lighting the liquid crystal panel,
the lighting apparatus comprising
light sources, and
a planar light conductor,
the planar light conductor including opposed surfaces, side surfaces and end surfaces,
a plurality of prisms being provided on one end surface,
said plurality of prisms having configurations varied in accordance with positions thereof,
the light sources being arranged so that light can be incident on the side surfaces from position near said one end surface, and
one of the opposed surfaces having means for causing the light propagating inside the planar light conductor to exit.

11. A liquid crystal display comprising:
a liquid crystal panel; and
a lighting apparatus for lighting the liquid crystal panel,
the lighting apparatus comprising
light sources, and
a planar light conductor,
the planar light conductor including opposed surfaces, side surfaces and end surfaces,
a plurality of prisms being provided on one end surface,
the light sources being arranged so that light can be incident on the side surfaces from position near said one end surface,
the planar light conductor having a groove or a slit near said a plurality of prisms, and
one of the opposed surfaces having means for causing the light propagating inside the planar light conductor to exit.
